(19) United States
(12) Patent Application Publication
(10) Pub. No.: US 2001/0037744 A1
(43) Pub. Date: Nov. 8, 2001

(54) Sheet roll and discrimination device thereof

(76) Inventors: Kenji Ohshima, Ibaraki (JP); Hideo Negishi, Ibaraki (JP); Kouichiro Iida, Ibaraki (JP)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/805,184

(22) Filed: Mar. 14, 2001

(30) Foreign Application Priority Data
Mar. 14, 2000 (JP) P.2000-070778

(51) Int. Cl. B41F 1/00; B41L 1/00; B41M 1/00

(52) U.S. Cl. 101/494

(57) ABSTRACT

There is provided a target (74) in a hollow portion formed in a stencil sheet roll (72). A stencil printing machine (12) includes at least one of a distance sensor (82) for measuring a position of the target (74) and a measurement device for measuring a color. The stencil printing machine (12) further includes a discrimination device for discriminating a type of the stencil sheet roll (72) in accordance with the measured position of the target (72) or in accordance with the obtained color information of the target (72). It is possible to discriminate various types of stencil sheet rolls with a simple structure. Therefore, it is possible to prevent a wrong stencil sheet roll from being set in the stencil printing machine (12).

### BACKGROUND OF THE INVENTION

1. Field of the Invention

The present invention relates to a sheet roll used for a printing machine, a copier, etc., and also relates to a discrimination device for discriminating a type of the sheet roll. The present invention is applicable to any sheet rolls that can be used in a printing apparatus, a printing machine, a copier, a facsimile apparatus, etc. For example, the sheet roll includes a stencil sheet roll, a printing sheet roll, a copy sheet roll, etc. It should be noted that the sheet material of the sheet roll is not limited to paper. In other words, such the sheet rolls, to which the present invention is applicable, should also be considered as any printable sheet rolls.

The present application is based on Japanese Patent Application No. 2000-070778, which is incorporated herein by reference.

2. Description of the Related Art

For example, a typical, thermographic-stencil-sheet roll used in a stencil printing machine for printing is comprised of a cartridge in which a long, thermographic-stencil-sheet is wound round a core tube (e.g., a sheet tube, a paper tube, etc.) which is made from a secondhand corrugated fiberboard and formed in a tubular manner. Therefore, the thermographic-stencil-sheet roll can be easily replaced in the case of consumption of the stencil sheet. With respect to the stencil sheet roll, there are provided a plurality of stencil sheet rolls in types thereof, because the thickness, material, sensitivity, width and quantity of winding of stencil sheet are different according to the type of a stencil printing machine. If a stencil sheet roll does not correspond to a stencil printing machine, and is incorporated into the stencil printing machine, it is impossible to normally conduct printing.

Therefore, in order to discriminate the type of a stencil sheet roll, there is proposed a stencil sheet roll in which a cutout, a recess, or the like is formed in an end portion of the core tube according to the type of a stencil sheet roll, also there are proposed stencil sheet rolls which are different in respective inner diameters thereof. However, such stencil sheet rolls may encounter the following problems.

The number of types of stencil sheet rolls, which can be discriminated, is smaller in comparison with the actual number of types of the stencil sheet rolls. Therefore, it is impossible to discriminate all stencil sheet rolls. Further, since a profile of the core tube is complicated, and therefore renders the manufacturing cost high.

### SUMMARY OF THE INVENTION

The present invention has been conceived in view of the above circumstances. It is an object of the present invention to provide a sheet roll and discrimination device therefor capable of discriminating a large number of types of sheet rolls by a simple structure, so that the sheet roll can be prevented from being erroneously mounted.

To achieve the above object, according to a first aspect of the present invention, there is provided a sheet roll which comprises a sheet rolled in a tubular manner to form a hollow portion therein, and a target disposed in the hollow portion.

According to a second aspect of the present invention, preferably, the sheet roll according to the first aspect further comprises a core tube disposed in the hollow portion, wherein the sheet is rolled round the core tube, and wherein the target is located in the core tube.

According to a third aspect of the present invention, preferably, the target according to the first and second aspects is colored.

According to a fourth aspect of the present invention, preferably, the target according to the first, second and third aspects has an opening formed therein.

According to a fifth aspect of the present invention, preferably, a position of the target is measured by a target position measuring device, and wherein a type of the sheet roll is discriminated by a discrimination device in accordance with positional information on the target provided by the target position measuring device.

According to a sixth aspect of the present invention, preferably, a color of the target is measured by a target color measuring device, and wherein a type of the sheet roll is discriminated by a discrimination device in accordance with color information on the target provided by the target color measuring device.

Therefore, to achieve the above object, according to a seventh aspect of the present invention, there is provided a sheet roll discrimination device for discriminating a type of a sheet roll. The sheet roll discrimination device comprises a target position measuring device which measures a position of a target which is disposed in a hollow portion formed in a sheet roll, and a discrimination device which discriminates a type of the sheet roll in accordance with positional information on the target provided by the target position measuring device.

According to an eighth aspect of the present invention, preferably, the target position measuring device according to the seventh aspect includes an ultrasonic distance measuring device.

According to a ninth aspect of the present invention, preferably, the target position measuring device according to the seventh aspect includes a photoelectric distance measuring device.

According to a tenth aspect of the present invention, preferably, the target position measuring device according to the seventh aspect includes a contact type distance measuring device.

According to an eleventh aspect of the present invention, preferably, the sheet roll according to the seventh aspect comprises a sheet rolled in a tubular manner to form the hollow portion.

According to a twelfth aspect of the present invention, preferably, the sheet roll according to the seventh aspect further comprises a core tube disposed in the hollow portion, wherein the sheet is rolled round the core tube, and wherein the target is located in the core tube.

According to a thirteenth aspect of the present invention, preferably, the target according to the eleventh and twelfth aspects has an opening formed therein.

Further, to achieve the above object, according to a fourteenth aspect of the present invention, there is provided a sheet roll discrimination device for discriminating a type of a sheet roll. The sheet roll discrimination device comprises a target color measuring device which measures a color of a target which is disposed in a hollow portion formed in a sheet roll, and a discrimination device which discriminates a type of the sheet roll in accordance with color information on the target provided by the target position measuring device.

According to a fifteenth aspect of the present invention, preferably, the sheet roll according to the fourteenth aspect comprises a sheet rolled in a tubular manner to form the hollow portion.

According to a sixteenth aspect of the present invention, preferably, the sheet roll according to the fifteenth aspect further comprises a core tube disposed in the hollow portion, wherein the sheet is rolled round the core tube, and wherein the target is located in the core tube.

According to a seventeenth aspect of the present invention, preferably, the target according to the fifteenth and sixteenth aspects has an opening formed therein.

In accordance with any one of the aspects of the present invention, it is possible to discriminate a large number of types of sheet rolls by a simple structure, and also it is possible to prevent the sheet roll from being erroneously mounted.

### BRIEF DESCRIPTION OF THE DRAWINGS

FIG. 1 is a view showing an inner structure of a stencil printing machine according to the present invention, into which a sheet roll and a discriminating device are incorporated;

FIG. 2 is a perspective view showing a sheet roll and a discrimination device according to the present invention;

FIG. 3 is a perspective view showing a discrimination device according to the present invention, which has an ultrasonic distance measurement device, and discriminates the type of a sheet roll;

FIG. 4 is a perspective view showing a discrimination device according to the present invention, which has a photoelectric type distance measurement device, and discriminates the type of a sheet roll;

FIG. 5 is a cross-sectional view showing another embodiment of a discrimination device according to the present invention, which has a photoelectric type distance measurement device, and discriminates the type of a sheet roll;

FIG. 6 is a perspective view showing a discrimination device according to the present invention, which has a contact type distance measurement device, and discriminates the type of a sheet roll;

FIG. 7 is a perspective view showing another embodiment of a sheet roll which can be discriminated according to the present invention; and

FIG. 8 is a perspective view showing another embodiment of a sheet roll which can be discriminated according to the present invention.

### DETAILED DESCRIPTION OF THE PREFERRED EMBODIMENTS

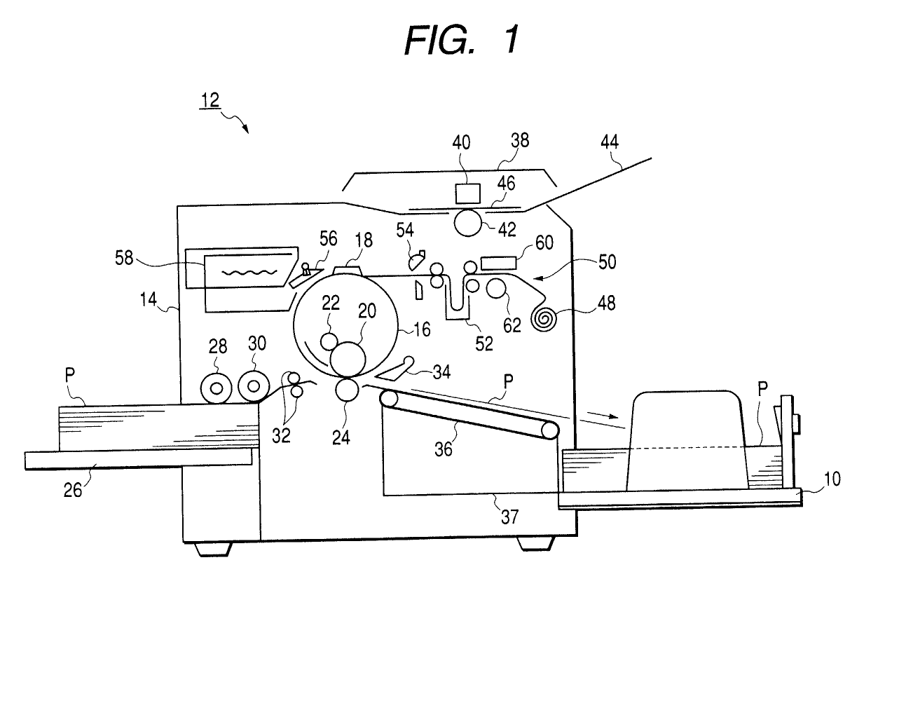

Preferred embodiments of the present invention now will be described in detail hereinbelow with reference to FIGS. 1 to 8.

FIG. 1 is a view showing an inner structure of a stencil printing machine 12 according to the present invention, into which a sheet roll and a discriminating device are incorporated.

The stencil printing machine 12 has a main body 14 in which a rotary cylindrical drum 16 rotatably disposed. On an outer circumferential surface of the rotary cylindrical drum 16, there is provided a clamping member 18 for holding an end portion of a stencil sheet when the stencil sheet is attached onto the outer circumferential surface of the rotary cylindrical drum 16. In the rotary cylindrical drum 16, there are provided a squeegee roller 20 coming into contact with an inner circumferential surface of the rotary cylindrical drum 16 and a doctor roller 22 for supplying printing ink to the squeegee roller 20. Right below the rotary cylindrical drum 16, there is provided a press roller 24. The press roller 24 is arranged at a position opposing to the squeegee roller 20. Further, the press roller 24 can be vertically moved, so that the press roller 24 can be contacted with and separated from the outer circumferential surface of the rotary cylindrical drum 16.

On the left side of the main body 14 in FIG. 1, there is provided a sheet supplying tray 26 on which printing sheets P are stacked. In an upper portion of the sheet supplying tray 26, there are provided a scraper 28 and a pickup roller 30 for feeding the printing sheets P one by one toward the rotary cylindrical drum 16. A pair of upper and lower timing rollers 32 are arranged adjacent to the pickup roller 30. In accordance with the timing rollers 32, a printing sheet P can be accurately fed out while interlocking with the motions of the rotary cylindrical drum 16 and the press roller 24. In this connection, the scraper 28 and the pickup roller 30 have one-way clutches built-in. Further, the scraper 28 and the pickup roller 30 are rotated in accordance with a printing sheet P when the printing sheet P is conveyed by the timing rollers 32.

On the right side of the rotary cylindrical drum 16 in FIG. 1, there are provided a peeling-off claw 34, a conveyance belt 36 and a suction unit 37. A printing sheet P is separated from the rotary cylindrical drum 16 by the peeling-off claw 34. The thus-separated printing sheet P is sucked by the suction unit 37 to be conveyed onto the conveyance belt 36, and then is discharged onto the sheet discharging tray 10 by the conveyance belt 36.

A cover 38 is disposed on an upper portion of the main body 14. On the reverse side of the cover 38, there is provided a line image sensor 40. On an upper surface of the main body 14 opposing to the line image sensor 40, there is provided an original separating roller 42 in such a manner that an upper portion of the original separating roller 42 is protruded from the main body 14. Reference numeral 44 designates an original stand. By utilizing the original stand 44, an original 46 can be supplied from the outside to between the original separating roller 42 and the line image sensor 40.

In the main body 14, there is rotatably provided a stencil sheet roll in which a stencil sheet 48 is wound. From the position, at which the stencil sheet roll is located, to the rotary cylindrical drum 16, there are provided a stencil making section 50, a stencil stock box 52, a cutter 54, etc. Further, a stencil discharging box 58 having a stencil discharging claw 56 is provided on the opposite side to the cutter 54 with respect to the rotary cylindrical drum 16. The stencil making section 50 has a thermal head 60 and a platen roller 62 which is opposed to the thermal head 60.

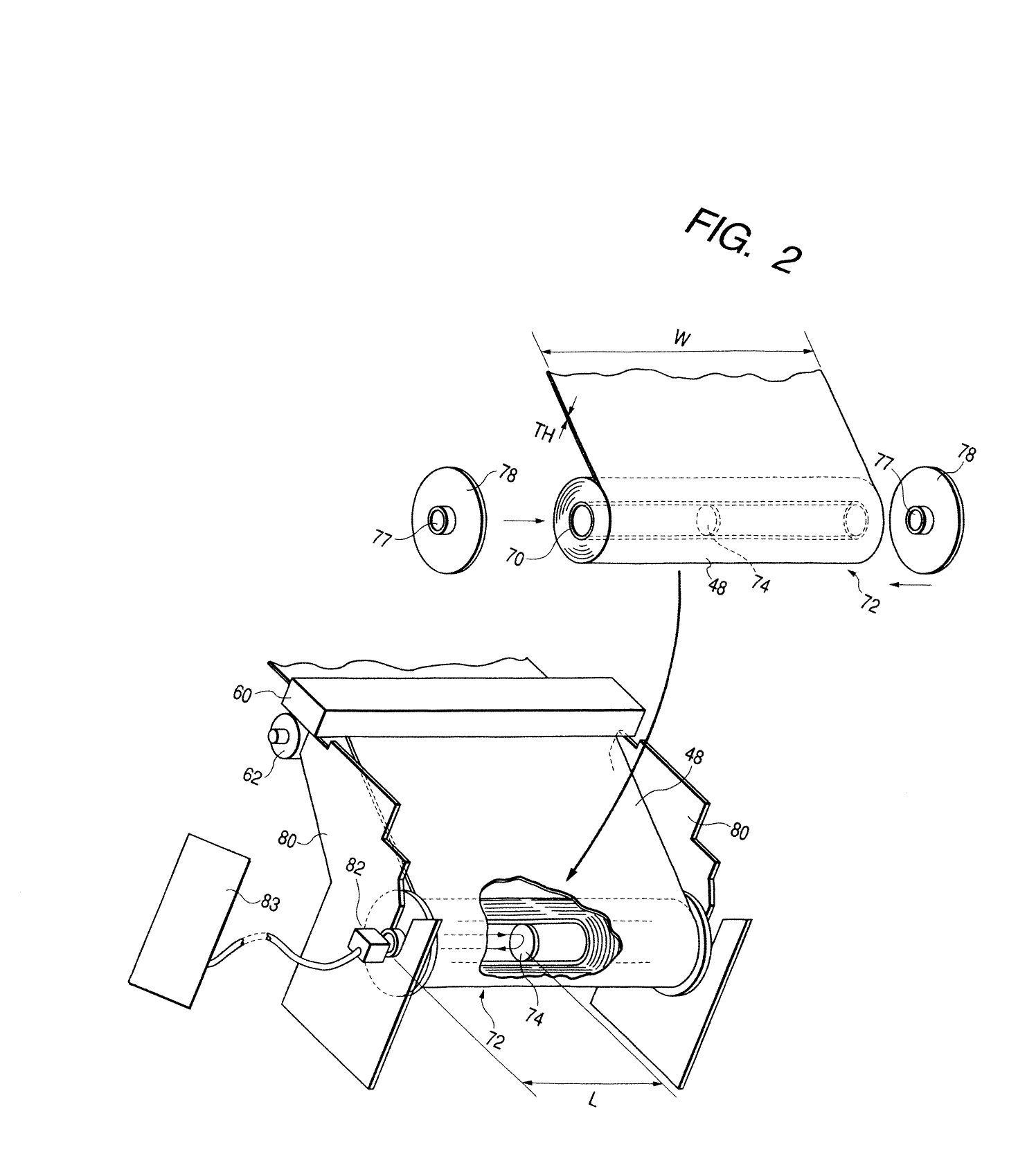

FIG. 2 is a perspective view showing a sheet roll and a discrimination device according to the present invention.

As shown in FIG. 2, the long stencil sheet 48 is wound round a hollow sheet tube 70. Thus, the long stencil sheet 48 is formed into a stencil sheet roll 72. The sheet tube 70 may be made of paper such as a secondhand corrugated fiberboard as described above but, need not be limited thereto. Alternatively, the sheet tube 70 may be made of a plastic, and may be integrally formed with the plastic. In either case, the object of the present invention can be achieved. In the embodiment, a target 74 is disposed in the sheet tube 70. It should be noted that the thickness TH (mm), material, sensitivity, width W (mm) and quantity of winding of the stencil sheet 48 are different in accordance with the use and the stencil printing machine 12. Therefore, at least one of a position L (mm) of the target 74 (e.g., a distance to the target 74 from the end portion side of the sheet tube 70) and a color of the target 74 may be changed according to the type of the stencil sheet. With respect to the material of the target 74, an appropriate material is selected, taking a detection deice for detecting the target 74 into consideration. The target 74 is fixed at a predetermined position in the sheet tube 70 by way of engagement or adhesion to which additive is applied.

In case where the thus-constructed stencil sheet roll 72 is attached to the stencil printing machine 12, flanges 78, 78 having openings 77, 77 are attached onto opposite sides of the stencil sheet roll 72, and then the stencil sheet roll 72 is attached to the attaching sections of the side plates 80, 80 arranged in the stencil printing machine 12. Then, the stencil sheet 48 of a predetermined length is drawn out from the stencil sheet roll 72, and a cover of a stencil sheet roll attaching section (not shown) is closed. Then, a command for designating the attachment of the stencil sheet is given via an input device (not shown) of the stencil printing machine 12. After that, the stencil sheet 48 can be automatically supplied.

It should be noted that, in the stencil printing machine 12, there is provided a distance sensor 82 which is disposed close to one of the flanges 78. The distance sensor 82 is capable of measuring the distance L (mm) to the target 74 through the opening 77 of the flange 78. Alternatively, the distance sensor 82 may be capable of measuring a color of the target 74 through the opening 77. The distance information or color information obtained by the distance sensor 82 is transmitted to a control unit 83 of the stencil printing machine 12.

In this way, the control unit 83 of the stencil printing machine 12 is capable of obtaining the information on a distance L (mm) to the target 74 which has been detected by the distance sensor 82 through the opening 77 of the flange 78. Then, the control unit 83 discriminates whether the stencil sheet roll 72 attached to the stencil printing machine 12 is appropriate to the stencil printing machine 12. In the case where it has been discriminated that the stencil sheet roll 72 is available, printing is carried out. However, in the case where the stencil sheet roll 72 is not available, that is, in the case where the stencil sheet roll 72 is for another type of stencil printing machine, an error message is displayed on a display device (not shown), so that the user is informed that the stencil sheet roll 72 is wrong.

When the aforementioned discrimination device for discriminating the type of the stencil sheet 48 is used, it is possible to easily discriminate the available stencil sheet roll 72 among various types of stencil sheet rolls. Further, it is possible to discriminate more various types of stencil sheet rolls when at least one of a bar code, a cutout and a protrusion is provided at the core tube end portion, and also when a core tube of a different diameter and the stencil sheet roll according to the present invention are combined with each other.

Next, an embodiment of the discrimination device for discriminating the type of the stencil sheet roll 72 according to the present invention will be explained as follows.

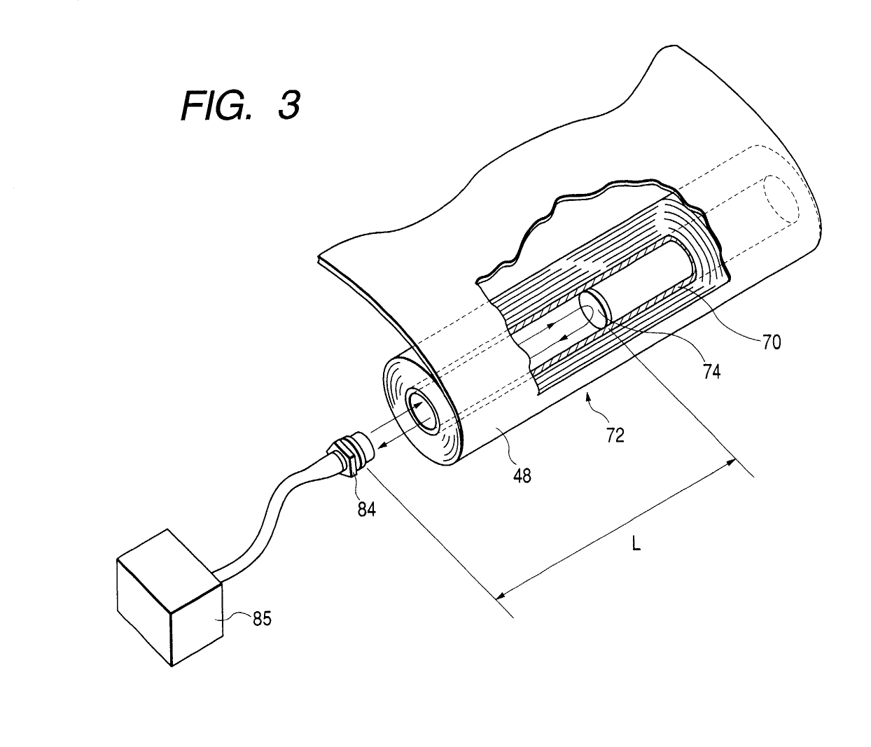

FIG. 3 is a perspective view showing a discrimination device according to the present invention, which has an ultrasonic distance measurement device, and discriminates the type of a sheet roll.

As shown in FIG. 3, the stencil printing machine 12 includes an ultrasonic distance sensor 84. The ultrasonic distance sensor 84 is connected to an ultrasonic signal transmitting and receiving device 85. Therefore, the ultrasonic distance sensor 84 transmits an ultrasonic signal to the target 74 and receives the ultrasonic signal from the target 74.

The ultrasonic signal transmitting and receiving device 85 includes: an ultrasonic oscillator; a transmitting and receiving circuit for amplifying the ultrasonic signal output from the ultrasonic oscillator and sending it to the ultrasonic distance sensor 84; and a receiving circuit which receives an ultrasonic wave reflected on the target 74 and received by the ultrasonic distance sensor 84, and which has such a function as a comparator amplifying and detecting the reflected signal so as to judge the timing of the reception of the signal. A distance L (mm) from the ultrasonic distance sensor 84 to the target 74 is calculated from a difference between the transmitting time and the receiving time of the ultrasonic wave and from a sound velocity. The thus calculated distance information is transmitted to the control unit 83 of the stencil printing machine 12, and it is discriminated whether the stencil sheet roll 72 corresponds to the type of the stencil printing machine 12.

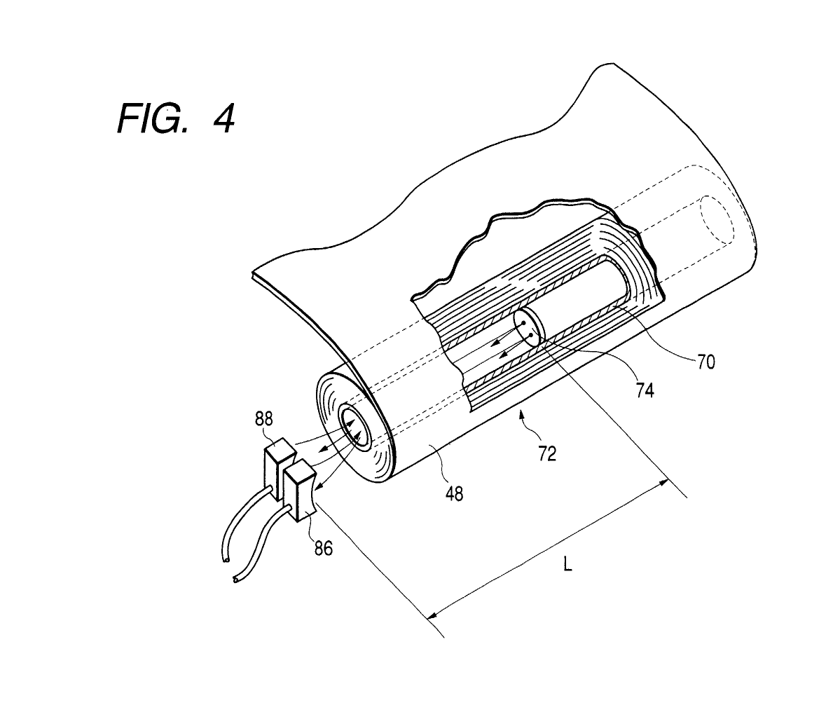

FIG. 4 is a perspective view showing a discrimination device according to the present invention, which has a photoelectric type distance measurement device, and discriminates the type of a sheet roll.

The stencil printing machine 12 may include at least one photoelectric sensor. In FIG. 4, photoelectric sensors 86, 88 are shown in order to easily understand the following description of this embodiment. The photoelectric sensors 86, 88 transmit and receive light, so that a distance to the target 74 or a color of the target 74 can be measured.

The control unit 83 of the stencil printing machine 12 calculates a distance L (mm) to the target 74 by the distance information obtained by the photoelectric sensor 86. From the thus calculated distance information, it is discriminated whether the stencil sheet roll 72 is appropriate to the type of the stencil printing machine 12. Discrimination of the stencil sheet roll 72 may be conducted by the color information of the target 74 obtained by the photoelectric sensor 88.

In the case where the photoelectric sensor 86 is of the type of measuring a distance to the target 74, the photoelectric sensor 86 may be a photoelectric sensor of the triangulation system. Alternatively, the photoelectric sensor 86 may be a photoelectric sensor of a system in which a quantity of spot light generated in the target 74 is measured. In either case, the object of the present invention can be accomplished. The aforementioned photoelectric sensor 86 may be constructed as follows. A plurality of photoelectric sensors, the measurement distances of which are different from each other, may jointly be used. In this case, one of the sets of information output from the plurality of photoelectric sensors is selected so that a wide range of distance from a short distance of the target 74 to a long distance can be measured.

In the case where the photoelectric sensor 88 is of the type of discriminating the color of the target 74, the photoelectric sensor 88 may be comprised of three types of light emitting elements (for example, LED) to emit light of red, green and blue, which are three primary colors, and a light receiving element to detect reflection light reflected by the target. In this structure, the light emitting elements of the above colors are successively emitted and the reflection light of each color is successively caught, and then a quantity of light of each color is compared. In this way, the target color can be discriminated. Alternatively, it is possible to adopt a structure having one light emitting element which emits natural light and also having filters, the transmitting colors of which are red, green and blue, arranged in the light emitting element so that the filters can be changed over. In this structure, when the filters are successively changed over and reflected light is taken from each filter into the light receiving element and a quantity of light of each color is compared, it is possible to discriminate the target color. That is, in the above two structures, the characteristic, in which a quantity of reflected light is reduced when the wavelength of light irradiating the target is close to the wavelength corresponding to the target color, is utilized.

In this connection, in the above embodiment, one set of the target 74 and the distance sensor are provided. However, the present invention is not limited to the above specific embodiment. When two targets 74 are arranged at two positions in the hollow portion of the stencil sheet roll 72 and the positions of the two targets 74 are measured from both sides of the stencil sheet roll 72, it is possible to discriminate more various types of discrimination by discriminating the stencil sheet roll 72 according to the combination of the two sets of the targets 74, 74.

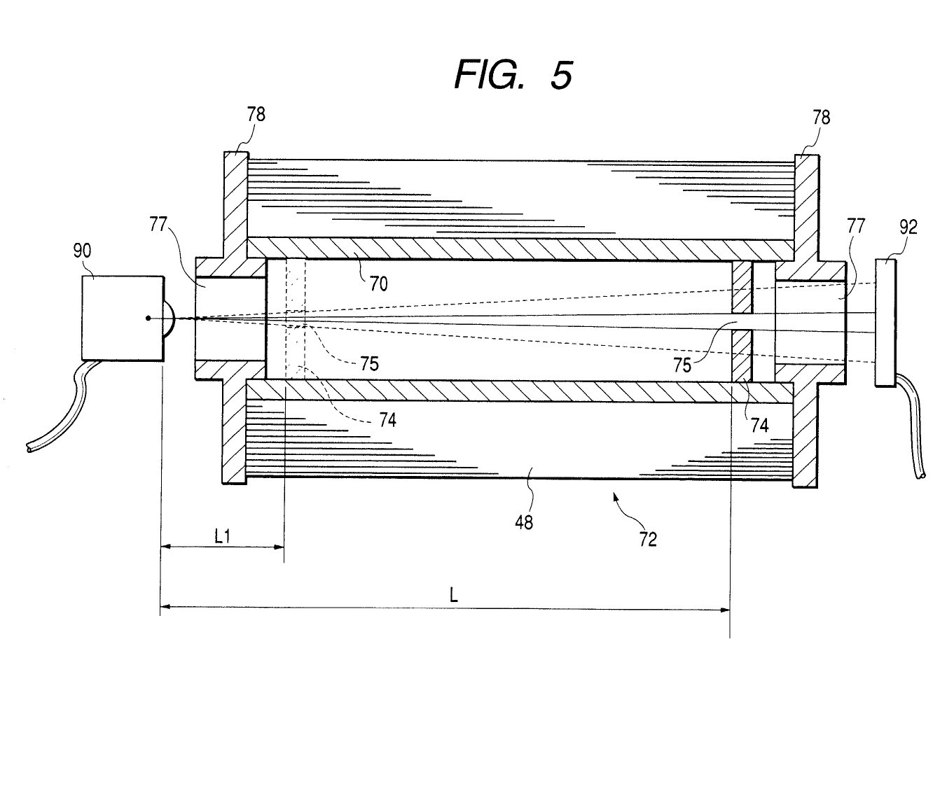

FIG. 5 is a cross-sectional view showing another embodiment of a discrimination device according to the present invention, which has a photoelectric type distance measurement device, and discriminates the type of a sheet roll.

As shown in FIG. 5, in the stencil printing machine 12, there is provided a light emitting section 90 of a photoelectric sensor which is arranged close to the flange 78 attached to the stencil sheet roll 72 incorporated into the stencil printing machine 12. A beam of light emitted from the light emitting section 90 passes in the opening 77 formed on the flange 78 and is irradiated on the target 74. The target 74 has an opening 75, and a portion of light irradiated from the light emitting section 90 passes in the opening 75 and irradiated into the light receiving section 92 arranged close to the flange 78 on the opposite side to the light emitting section 90.

As shown in FIG. 5, when the target 74 is located at a position L1, a quantity of light received by the light receiving section 92 is large. On the other hand, when the target 74 is located at a position L, a quantity of light received by the light receiving section 92 is small. Therefore, when the quantity of received light is detected, it becomes possible to measure the position where the target 74 is located.

The light receiving section 92 outputs a signal, which corresponds to the quantity of received light, to the control unit 83 of the stencil printing machine 12, and the control unit 83 converts the quantity of light received by the light receiving section 92 into a distance L (mm). From the distance information calculated here, it is discriminated whether the stencil sheet roll 72 is appropriate to the type of the stencil printing machine 12.

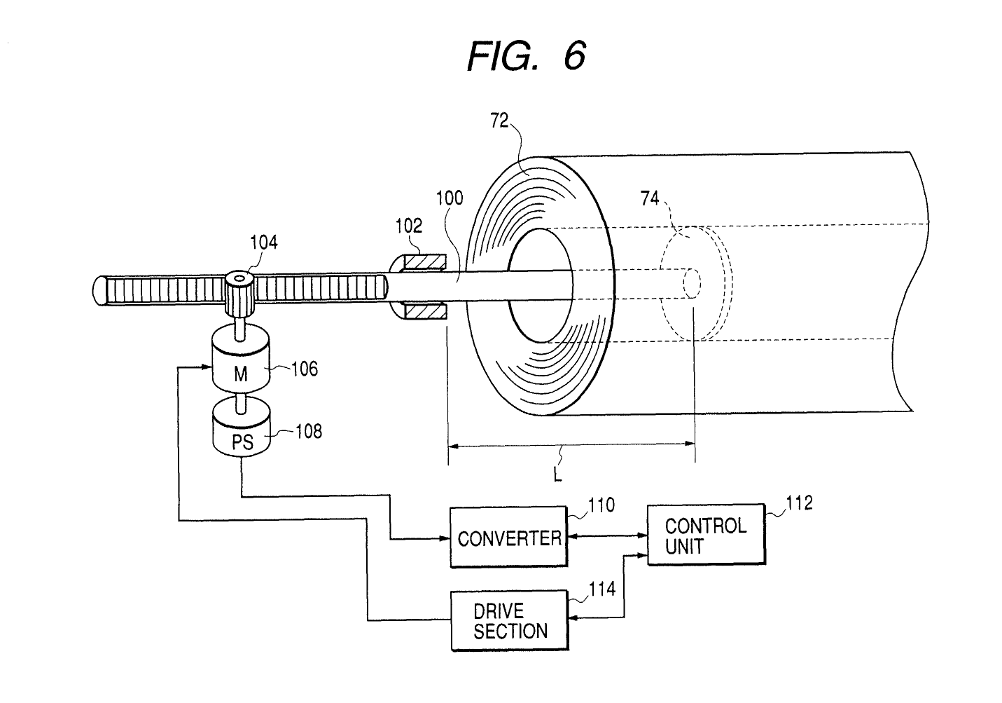

FIG. 6 is a perspective view showing a discrimination device according to the present invention, which has a contact type distance measurement device, and discriminates the type of a sheet roll.

As shown in FIG. 6, a detection rod 100 is guided by a guide ring 102 in the axial direction of the stencil sheet roll 72 and at the same time inserted into the hollow portion of the stencil sheet roll 72. A forward end of the detection rod 100 is contacted with the target 74, which is arranged inside the stencil sheet roll 72, by a pushing member (not shown) such as a spring etc.

Teeth meshed with a pinion 104 are provided in a portion of the detection rod 100. Therefore, when the detection rod 100 is moved in the axial direction of the stencil sheet roll 72, the pinion 104 is rotated in accordance with a quantity of the movement of the detection rod 100. A rotary shaft of the pinion 104 is the same as that of a motor 106 and a position detector 108. Therefore, it is possible to give a rotary torque to the pinion 104, and also it is possible to detect a moving position of the detection rod 100.

In this connection, a signal of the position detector 108 is transmitted to a converter 110, and the converter 110 converts the signal representing a quantity of movement of the detection rod 100 into data, the format of which can be read by a control unit 112. The position detector 108 may be a variable resistor which is capable of detecting a rotary angle when the resistance is continuously changed in accordance with the rotation. Alternatively, the position detector 108 may be an encoder to count the number of grids.

According to the thus obtained positional information of the target 74, the control unit 112 of the stencil printing machine 12 discriminates whether the stencil sheet roll 72, which has been set in the stencil printing machine at present, is appropriate to the stencil printing machine 12.

In the case of replacing the stencil sheet roll 72, the control unit 112 outputs a command to the drive section 114 so as to rotate the motor 106 in the direction in which the detection rod 100 is drawn out from the hollow portion of the stencil sheet roll 72.

When a distance L (mm) to the target 74 is measured by the contact type distance measuring device constructed as described above, the type of the stencil sheet roll 72 can be discriminated.

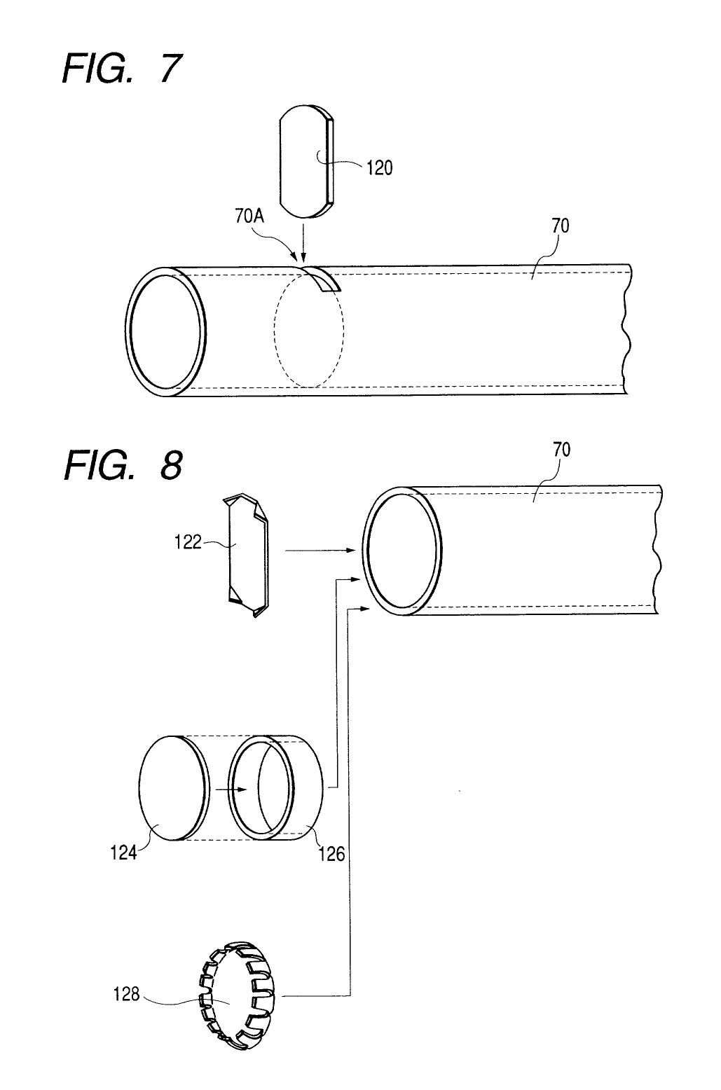

FIG. 7 is a perspective view showing another embodiment of a discriminatable sheet roll according to the present invention.

As shown in FIG. 7, there is provided an opening 70A in a sheet tube 70. A rectangular flat target 120, both end portions of which are formed into a circular shape, is inserted into this opening 70A and fixed by way of adhesion. When the target 120 is attached to the sheet tube 70 in this way, it is possible to insert the target 120 from the outside of the sheet tube 70. Therefore, the assembling work can be made easy. In this connection, a plurality of openings 70A may be provided if necessary.

FIG. 8 is a perspective view showing another embodiment of a discriminatable sheet roll according to the present invention.

As shown in FIG. 8, a target attached in a sheet roll or a sheet tube 70 may be formed into a rectangular flat shape, the corners of which are bent as shown by the reference numeral 122, and set in the sheet tube 70 by way of engagement or adhesion.

According to another embodiment, a target represented by reference numeral 124 may be fixed in a sleeve 126 and set in the sheet tube 70 by way of engagement or adhesion.

According to still another embodiment, as shown by a target represented by reference numeral 128, a circumference of a disk-shaped target is radially cut out, and the thus cutout circumference portion, which has been cut out so that it can fit to the inner diameter of the sheet tube 70, may be bent and set in the sheet tube 70 by way of engagement or adhesion.

Although the above-described embodiments are discussed by utilizing stencil sheet rolls that can be used in the stencil printing machine, it should be noted that the sheet rolls, to which the present invention is applicable, are not limited to the stencil sheet rolls. Further, in the above-described embodiments, there are discussed examples in which any types of sheet rolls can be discriminated by utilizing the discrimination device according the present invention. Accordingly, the discrimination device according to the present invention may also be applied to a printing sheet roll, a copy sheet roll used for a copier, etc., the shape of which is formed into a roll cartridge shape.

As described above, according to the sheet roll of the present invention, there is provided a target in the hollow portion of the sheet roll. Therefore, it is possible to measure a position or color of the target by the discrimination device, and also it is possible to discriminate a type of the sheet roll according to the thus obtained position or color information. Accordingly, it is possible to discriminate various types of sheet rolls by a simple structure of the discrimination device, and a wrong sheet roll can be prevented from being erroneously set in the machine.

A sheet roll discrimination device according to the present invention comprises: a target color measuring device for measuring a color of the target arranged in the hollow portion of the sheet roll; and a discrimination device for discriminating the type of the sheet roll according to the measured color information of the target. Accordingly, it is possible to discriminate various types of sheet rolls by a simple structure of the discrimination device, and a wrong sheet roll can be prevented from being erroneously set in the machine.

What is claimed is:

1. A sheet roll, comprising:
a sheet rolled in a tubular manner to form a hollow portion therein; and
a target disposed in the hollow portion.

2. The sheet roll of claim 1, further comprising a core tube disposed in the hollow portion, wherein the sheet is rolled round the core tube, and wherein the target is located in the core tube.

3. The sheet roll of claim 1, wherein the target is colored.

4. The sheet roll of claim 1, wherein the target has an opening formed therein.

5. The sheet roll of claim 1, wherein a position of the target is measured by a target position measuring device, and wherein a type of the sheet roll is discriminated by a discrimination device in accordance with positional information on the target provided by the target position measuring device.

6. The sheet roll of claim 1, wherein a color of the target is measured by a target color measuring device, and wherein a type of the sheet roll is discriminated by a discrimination device in accordance with color information on the target provided by the target color measuring device.

7. A sheet roll discrimination device for discriminating a type of a sheet roll, comprising:
a target position measuring device which measures a position of a target which is disposed in a hollow portion formed in a sheet roll; and
a discrimination device which discriminates a type of the sheet roll in accordance with positional information on the target provided by the target position measuring device.

8. The sheet roll discrimination device of claim 7, wherein the target position measuring device includes an ultrasonic distance measuring device.

9. The sheet roll discrimination device of claim 7, wherein the target position measuring device includes a photoelectric distance measuring device.

10. The sheet roll discrimination device of claim 7, wherein the target position measuring device includes a contact type distance measuring device.

11. The sheet roll discrimination device of claim 7, wherein the sheet roll comprises a sheet rolled in a tubular manner to form the hollow portion.

12. The sheet roll discrimination device of claim 11, wherein the sheet roll further comprises a core tube disposed in the hollow portion, wherein the sheet is rolled round the core tube, and wherein the target is located in the core tube.

13. The sheet roll discrimination device of claim 11, wherein the target has an opening formed therein.

14. A sheet roll discrimination device for discriminating a type of a sheet roll, comprising:
a target color measuring device which measures a color of a target which is disposed in a hollow portion formed in a sheet roll; and
a discrimination device which discriminates a type of the sheet roll in accordance with color information on the target provided by the target position measuring device.

15. The sheet roll discrimination device of claim 14, wherein the sheet roll comprises a sheet rolled in a tubular manner to form the hollow portion.

16. The sheet roll discrimination device of claim 15, wherein the sheet roll further comprises a core tube disposed in the hollow portion, wherein the sheet is rolled round the core tube, and wherein the target is located in the core tube.

17. The sheet roll discrimination device of claim 15, wherein the target has an opening formed therein.
